(19) United States
(12) Patent Application Publication
(10) Pub. No.: US 2003/0230701 A1
(43) Pub. Date: Dec. 18, 2003

(54) Structure for hanging object

(76) Inventor: Teng-Yao Chang, Taichung (TW)

Correspondence Address: BACON & THOMAS, PLLC, 625 SLATERS LANE, FOURTH FLOOR, ALEXANDRIA, VA, 22314

(21) Appl. No.: 10/436,128

(22) Filed: May 13, 2003

(30) Foreign Application Priority Data
May 22, 2002 (TW) 91207333

(51) Int. Cl. F16M 11/00

(52) U.S. Cl. 248/682

(57) ABSTRACT

A structure for hanging objects is disclosed to include a base level, a first strap body, and a second strap body. The first strap body is bonded to the base level such that a plurality of first slots each having a predetermined breadth are formed between the first strap body and the base level. The second strap body is stackably bonded to the first strap body such that a plurality of second slots each having a predetermined breadth are formed between the first strap body and the second strap body. Each of the first slots corresponds to at least two of the second slots.

### BACKGROUND OF THE INVENTION

1. Field of the Invention

The present invention relates generally to hanging structures, and more particularly to a structure for hanging objects.

2. Description of the Related Art

A conventional structure for hanging objects, like mobile phones, phone cases, eyeglasses cases, and so on, is disposed on a regular backpack or briefcase or waist bag. Taking the backpack as an example, the structure has an elongated strap-like cloth that is stitched to an exterior side of the backpack equidistantly to form a plurality of slots arranged at an equidistant interval for inserting and clamping the objects or clamping members of the objects and otherwise further easily removing the objects or the clamping members.

However, the slots of the aforementioned structure for hanging objects each have the same breadth to receive the objects or the clamping members with one single dimension. While receiving the objects or the clamping members of different dimensions, which are smaller or larger than the slots, they are too small to be held tight or too large to be received inside the slots. Although the slots having different dimensions that are formed by stitching a plurality of cloths to the backpack at an different interval can hold and hang the objects and the clamping members of different dimensions, the backpack will not only have lots of area and space occupied and wasted, but also be aesthetically bad.

### SUMMARY OF THE INVENTION

The primary objective of the present invention is to provide a structure for hanging objects which can be different sized objects and their clamping members.

The secondary objective of the present invention is to provide a structure for hanging objects, and the structure is small-sized and aesthetically pretty.

The foregoing objectives of the present invention are attained by the structure, which is composed of a base level, a first strap body, and a second strap body. The first strap body is bonded to the base level and a plurality of first slots each having a predetermined breadth are formed between the first strap body and the base level. The second strap body is stackably bonded to the first strap body and a plurality of second slots each having a predetermined breadth are formed between the first strap body and the second strap body. Each of the first slots corresponds to at least two of the second slots.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a sectional view of the first preferred embodiment of the present invention hung with an object;

FIG. 4 is a sectional view of the first preferred embodiment of the present invention hung with another object;

FIG. 5 is a perspective view of the first preferred embodiment of the present invention applied to a backpack;

FIG. 6 is a perspective view of the first preferred embodiment of the present invention mounted on a waist belt;

FIG. 7 is a perspective view of a second preferred embodiment of the present invention;

FIG. 8 is a perspective view of a third preferred embodiment of the present invention; and

FIG. 9 is a perspective view of a fourth preferred embodiment of the present invention.

### DETAILED DESCRIPTION OF THE INVENTION

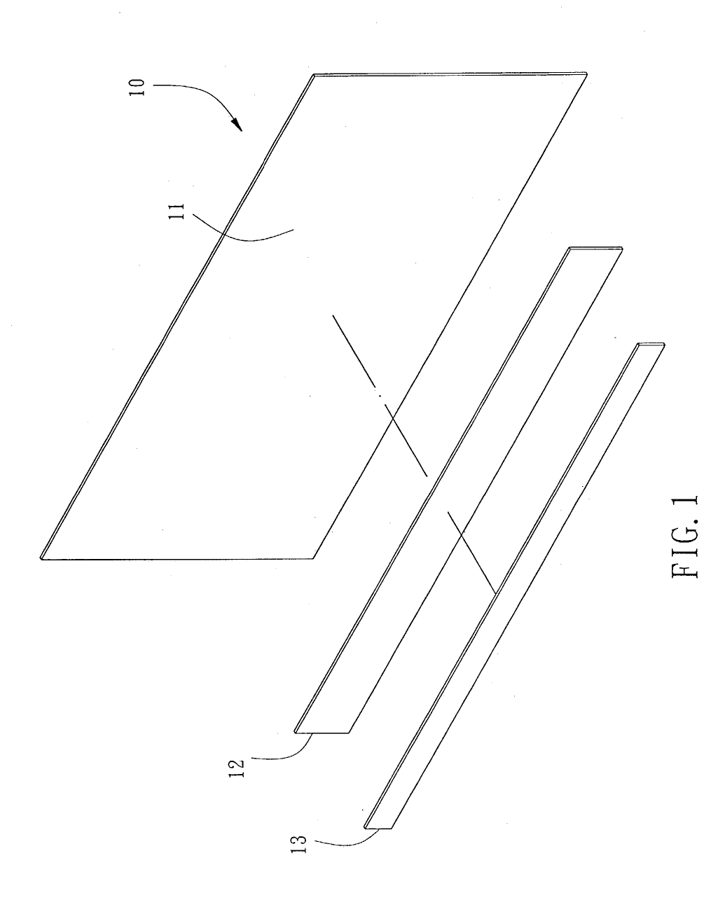

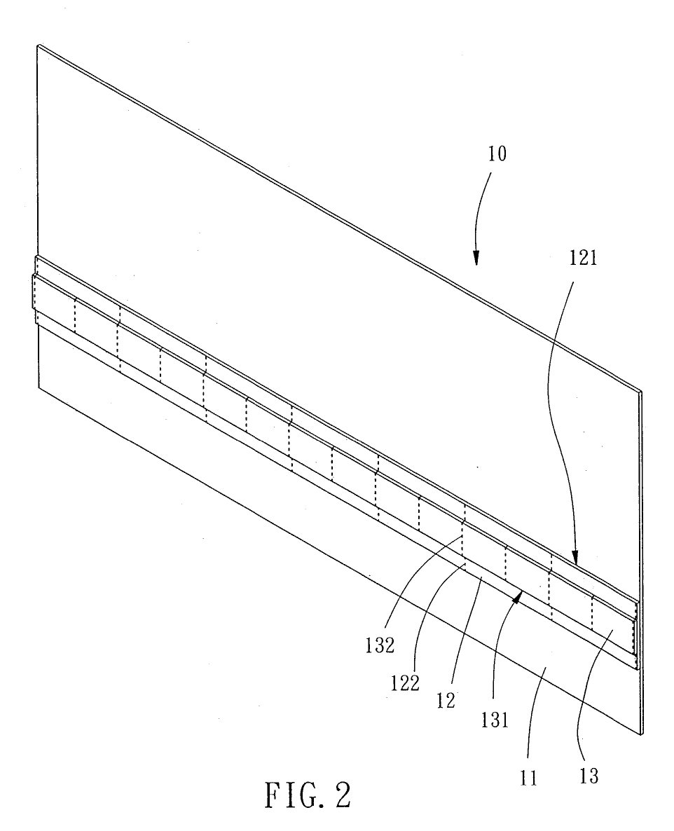

Referring to FIGS. 1-2, a structure 10 for hanging objects according to a first preferred embodiment of the present invention is composed of a base level 11, a first strap body 12, and a second strap body 13.

The base level 11 can be a surface of any of articles, like backpacks or waist belts or briefcases, for hanging the objects and has a predetermined area.

The first strap body 12 is an elongated strap-like cloth, defining a long axle and a short axle which is 2 inches in length, and is stitched to the base level 11 at a side thereof at predetermined intervals to form a plurality of first seams 122 arranged thereon at the predetermined intervals, thereby further defining a plurality of first slots 121 between the base level 11, the first strap body 12, and first seams 122. Each of the first slots 121 has a top end and a bottom end respectively in communication with the outside for the objects and their clamping members inserting therethrough, having a breadth of 3 in.

The second strap body 13 is an elongated strap-like cloth, defining a long axle and a short axle which is 1 inch in length, and is stackably stitched to the outer side of the first strap body 12 at predetermined intervals to form a plurality of second seams 132 arranged thereon at the predetermined intervals, thereby further defining a plurality of second slots 131 between the first strap body 12, the second strap body 13, and second seams 132. Each of the second slots 131 has a top end and a bottom end respectively in communication with the outside for the objects and their clamping members inserting therethrough, having a breadth of 1.5 in., i.e. the first slot 121 is twice in breadth as much as the second slot 131.

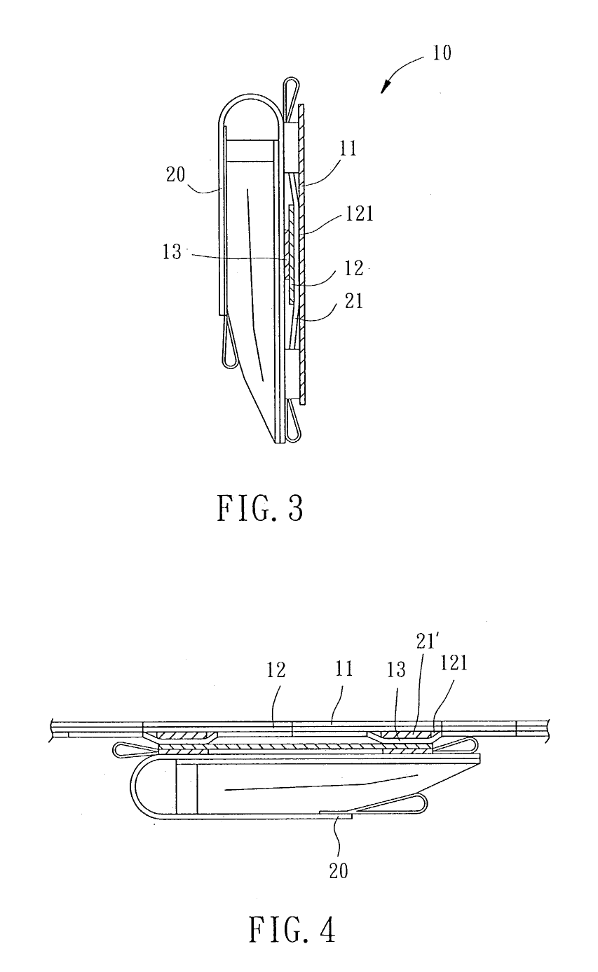

In operation, at first, insert a clamping member 21 of an object 20 into the first slot 121 or the second slot 131 according to the size of the clamping member 21. Referring to FIG. 3, the clamping member 21 embodied as a phone case clip is larger than the second slot 131 but smaller than the first slot 121 in breadth, i.e. the phone case clip is ranged in breadth between 1.5 in. and 3 in., such that the phone case clip can be inserted into the first slot 121 to be held and hung on the first strap body 12, thereby hanging the clamping member 21 on the structure 10. Referring to FIG. 4, the clamping member 21′ (phone case clip) is smaller in breadth than the second slot 131, i.e. the phone case clip is smaller than 1.5 in., such that the phone case clip can be inserted into the second slot 131 to be held and hung on the second strap body 12, thereby hanging the clamping member 21′ on the structure 10. Accordingly, the structure 10 of the present invention can conveniently hang the objects having different dimensions by occupying the minimal area.

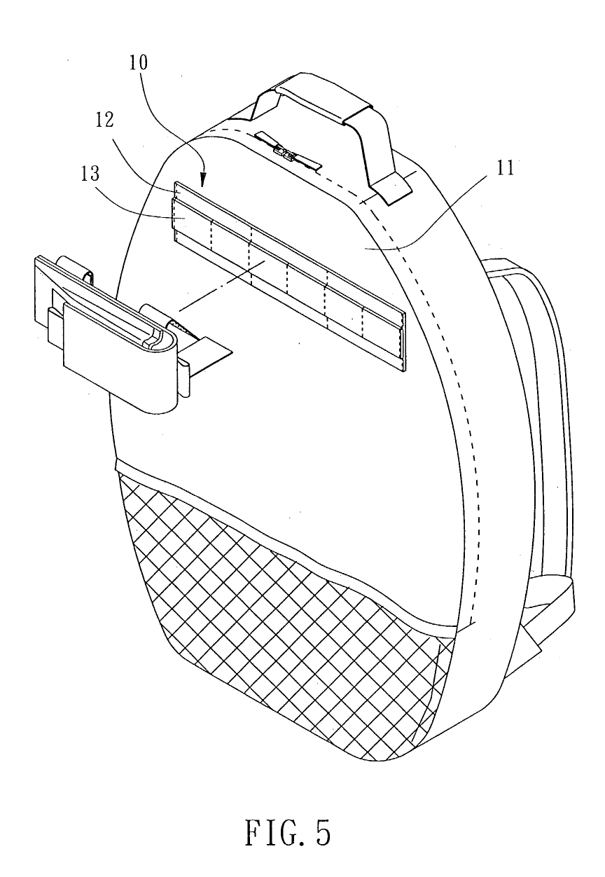

Referring to FIGS. 5 and 6, the structure 10 of the present invention is applied to a backpack and a waist belt, wherein the base level 11 is respectively embodied as two surfaces of the backpack and the waist belt.

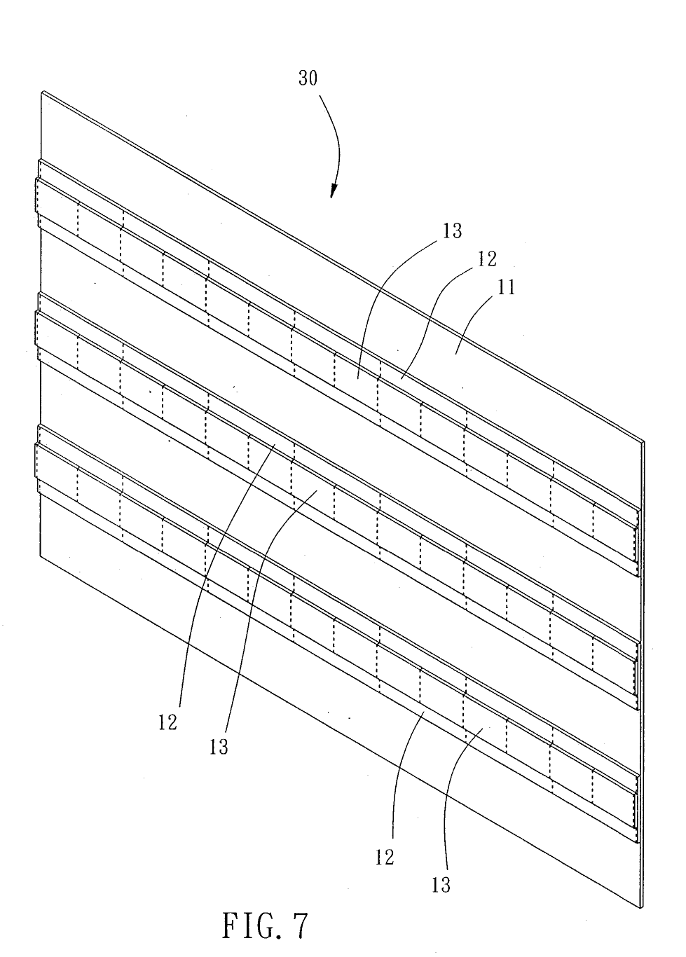

Referring to FIG. 7, a second preferred embodiment of the present invention differs from the first preferred embodiment only in that the structure 30 is composed of the base level 11 and at least two strap assemblies, each of which has at least two of the first strap bodies 12 and at least two of the second strap bodies 13, bonded to the base level 11.

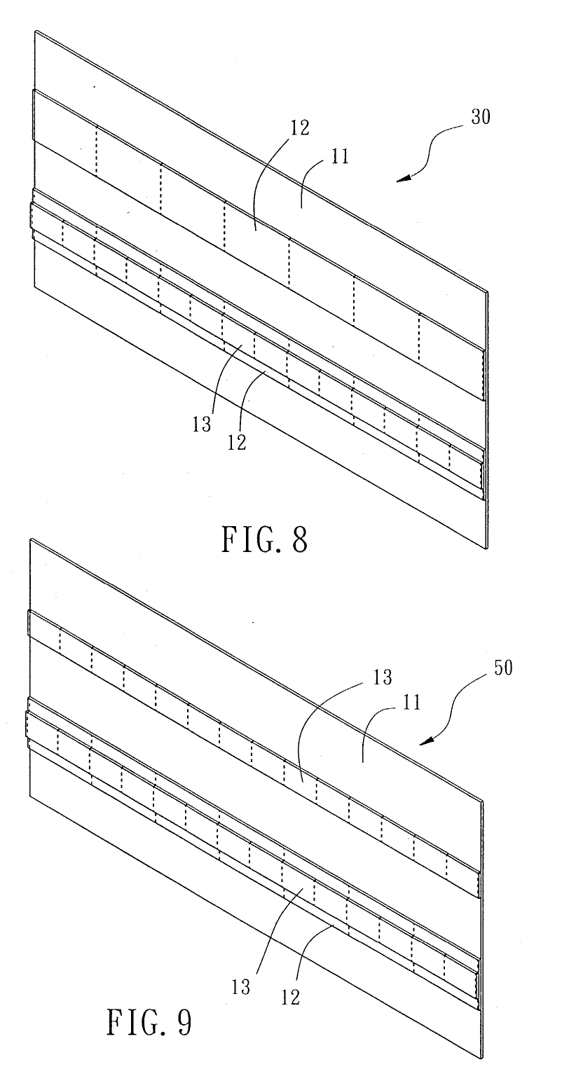

Referring to FIG. 8, a third preferred embodiment of the present invention differs from the aforementioned embodiments only in that the structure 40 is composed of the base level 11, the strap assembly having the first strap body 12 and the second strap body 13, and another first strap body 12. The strap assembly and the another first strap body 12 are respectively bonded to the base level 11.

Referring to FIG. 9, a fourth preferred embodiment of the present invention differs from the aforementioned embodiments only in that the structure 50 is composed of the base level 11, the strap assembly having the first strap body 12 and the second strap body 13, and another second strap body 13. The strap assembly and the another second strap body 13 are respectively bonded to the base level 11.

In addition, the base level, the first strap body, and the second strap body are made of cloth, such that they can be connected by means of stitchery, buckles, adhesives, or others. Because the cloth is provided with resilience, cloths are tightly connected with one another while no objects are hung onto them. According to the regular manufacturing criteria of the clamping members of the objects, the first and second strap bodies are respectively 2 in. and 1 in. in length so as to accommodate regular objects.

In conclusion, the present invention includes advantages as follows.

1. Hanging the Objects of Various Dimensions:

The structure of the present invention has a plurality of the first slots and the second slots, which have different dimensions, so as to accommodate and hang the objects of various dimensions.

2. Space-Saving and Multiple Application Fields:

The structure of the present invention is stackably formed and takes little space so as to be space-saving, and can be further applied to various fields, like backpacks, waist belts, walls, or storage boxes so as to have multiple application fields. In addition, the present invention is low in production cost for consumers to have such benefits with low expense.

What is claimed is:

1. A structure for hanging objects comprising:
a base level;
a first strap body connected with said base level such that a plurality of first slots having predetermined breadth are formed between said base level and said first strap body; and
a second strap body stackably connected with said first strap body such that a plurality of second slots having predetermined breadth are formed between said first strap body and said second strap body, wherein each of said first slots corresponds to at least two of said second slots.

2. The structure as defined in claim 1, wherein said first strap body defines a long axle and a short axle having a length of 2 in.

3. The structure as defined in claim 1, wherein said second strap body defines a long axle and a short axle having a length of 1 in.

4. The structure as defined in claim 1, wherein each said first slot has a breadth of 3 in.

5. The structure as defined in claim 1, wherein each said second slot has a breadth of 1.5 in.

6. The structure as defined in claim 1, wherein said base level is connected with said first strap body by stitchery.

7. The structure as defined in claim 1, wherein said first strap body is connected with said second strap body by stitchery.
